(19) United States
(12) Patent Application Publication
(10) Pub. No.: US 2020/0083526 A1
(43) Pub. Date: Mar. 12, 2020

(54) SILICON-CARBON COMPOSITE MATERIAL AND METHOD FOR PREPARING THE SAME

(71) Applicant: Eternal Materials Co., Ltd., Kaohsiung City (TW)

(72) Inventors: Lin-Jen TSAI, Kaohsiung City (TW); Chih-Hsien WANG, Kaohsiung City (TW)

(21) Appl. No.: 16/426,018

(22) Filed: May 30, 2019

(30) Foreign Application Priority Data
Sep. 6, 2018 (TW) 107131341

(51) Int. Cl. H01M 4/36; H01M 4/38; H01M 4/62; H01M 4/583; C09C 1/30

(52) U.S. Cl. CPC H01M 4/366; H01M 4/386; H01M 2004/021; H01M 4/583; C09C 1/3063; H01M 4/625

(57) ABSTRACT

A silicon-carbon composite material includes a silicon-containing particle, a carbon covering layer enclosing the silicon-containing particle, and a conductive material included in at least one of the silicon-containing particle and the carbon covering layer. A ratio of an integral area of a characteristic peak of sp² carbon in an X-ray photoelectron spectrum of the silicon-carbon composite material to a total integral area of characteristic peaks of C1s orbital in the X-ray photoelectron spectrum is in a range from 0.7 to 0.9.

### CROSS-REFERENCE TO RELATED APPLICATION

This application claims priority of Taiwanese Application No. 107131341, filed on Sep. 6, 2018.

### FIELD

The disclosure relates to a silicon-carbon composite material, and more particularly to a silicon-carbon composite material for a cathode of a lithium battery. The disclosure also relates to a method for preparing the silicon-carbon composite material.

### BACKGROUND

Lithium-ion batteries have properties such as a relatively light weight, a high capacity (i.e., a high energy density), a high work voltage, a rechargeable cycle, a high cycle life, and the like, and are thus widely used as driving power supplies for portable electric devices and also as power supplies for electric vehicles and electric storages. However, electrochemical batteries such as lithium batteries have capacity degradation problem due to material variation and/or loss, and the like, which result from repeated charge/discharge operation of the batteries.

International Patent Publication No. WO 2008/025188 A1 discloses a silicon-carbon composite negative material for a lithium-ion battery. The silicon-carbon composite negative material improves the specific capacity of the lithium-ion battery and has excellent cycling performance. The silicon-carbon composite negative material is based on spherical or quasi-spherical composite particles coated with a carbon coating layer. The composite particles include silicon-phase particles and carbon-phase particles. The carbon coating layer includes pyrolytic carbon of an organic matter. The pyrolytic carbon of the organic matter is formed by subjecting a precursor thereof to a carbonization treatment at an elevated temperature ranging from 1000° C. to 1500° C. The precursor is selected from the group consisting of water-soluble polyvinyl alcohol, butadiene-styrene rubber, carboxymethyl cellulose, polystyrene, polymethyl methacrylate, polytetrafluoroethylene, polyvinylidene fluoride, polyacrylonitrile, phenolic resin, epoxy resin, glucose, sucrose, fructose, cellulose, starch, asphalt, and combinations thereof. When the silicon-carbon composite negative material is used for producing a cathode of a lithium-ion battery, the capacity holding ratio of the lithium-ion battery is unsatisfactory.

Therefore, there is still a need to develop a novel material for producing a cathode of a lithium-ion battery to enhance a capacity holding ratio of the lithium-ion battery.

### SUMMARY

A first object of the disclosure is to provide a silicon-carbon composite material for a cathode of a lithium-ion battery to enhance a capacity holding ratio of the lithium-ion battery.

A second object of the disclosure is to provide a method for preparing the silicon-carbon composite material.

According to a first aspect of the disclosure, there is provided a silicon-carbon composite material which includes a silicon-containing particle, a carbon covering layer enclosing the silicon-containing particle, and a conductive material included in at least one of the silicon-containing particle and the carbon covering layer. A ratio of an integral area of a characteristic peak of sp² carbon in an X-ray photoelectron spectrum of the silicon-carbon composite material to a total integral area of characteristic peaks of C1s orbital in the X-ray photoelectron spectrum is in a range from 0.7 to 0.9.

According to a second aspect of the disclosure, there is provided a method for preparing the silicon-carbon composite material, which includes the steps of:

(a) providing a mixture including the silicon-containing particle, the conductive material, and a carbon-containing organic material; and

(b) subjecting the mixture to a heat treatment at a temperature ranging from 250° C. to 600° C.

When the silicon-carbon composite material of the disclosure is used for a cathode of a lithium battery, the lithium battery can have an enhanced capacity holding ratio.

### DETAILED DESCRIPTION

A silicon-carbon composite material according to the disclosure includes a silicon-containing particle, a carbon covering layer enclosing the silicon-containing particle, and a conductive material included in at least one of the silicon-containing particle and the carbon covering layer. A ratio of an integral area of a characteristic peak of sp² carbon in an X-ray photoelectron spectrum of the silicon-carbon composite material to a total integral area of characteristic peaks of C1s orbital in the X-ray photoelectron spectrum is in a range from 0.7 to 0.9.

In the X-ray photoelectron spectrum, the characteristic peaks of the C1s orbital is the characteristic peaks at a binding energy ranging from 280 eV to 298 eV, and includes the characteristic peak of sp² carbon (C═C), the characteristic peak of C—O (for example, C—OH or C—O—C), and the characteristic peak of C═O (for example, —C═O or O—C═O). When the ratio of the integral area of the characteristic peak of sp² carbon in the X-ray photoelectron spectrum of the silicon-carbon composite material to the total integral area of the characteristic peaks of the C1s orbital in the X-ray photoelectron spectrum is in a range from 0.7 to 0.9 (for example, 0.7, 0.75, 0.78, 0.8, 0.85, 0.88, or 0.97), the lithium battery thus produced has a high capacity and a high capacity holding ratio (i.e., a high cycle life). In certain embodiments, the ratio of the integral area of the characteristic peak of sp² carbon to the total integral area of the characteristic peaks of the C1s orbital is in a range from 0.75 to 0.85.

In certain embodiments, a ratio of an integral area of the characteristic peak of C═O in the X-ray photoelectron spectrum of the silicon-carbon composite material to the total integral area of the characteristic peaks of the C1s orbital in the X-ray photoelectron spectrum is in a range from 0 to 0.1, and a ratio of an integral area of the characteristic peak of C—O in the X-ray photoelectron spectrum of the silicon-carbon composite material to the total integral area of the characteristic peaks of the C1s orbital in the X-ray photoelectron spectrum is in a range from 0.05 to 0.25. In certain embodiments, the ratio of the integral area of the characteristic peak of C—O to the total integral area of the characteristic peaks of the C1s orbital is in a range from 0.10 to 0.22.

In certain embodiments, the silicon-carbon composite material according to the disclosure has a mean particle size ranging from 1 μm to 30 μm so as to permit the silicon-carbon composite material to be effectively dispersed in graphite used for a cathode.

In certain embodiments, the silicon-carbon composite material according to the disclosure has a specific surface area ranging from 1.0 m²/g to 30.0 m²/g so as to permit the silicon-carbon composite material to be easily mixed with the material (for example, graphite) used for the cathode.

In certain embodiments, the silicon-carbon composite material according to the disclosure has a tap density ranging from 0.3 g/cm³ to 2.0 g/cm³ so as to reduce or prevent the silicon-carbon composite material from absorbing solvent used for preparation of the cathode.

### Conductive Material:

The conductive material included in the silicon-carbon composite material according to the disclosure can be included in the silicon-containing particle, the carbon covering layer, or both of the silicon-containing particle and the carbon covering layer. Examples of the conductive material suitable for the silicon-carbon composite material according to the disclosure include, but are not limited to, polyethylenedioxythiophene (PEDOT), carbon black, graphite, graphene, and carbon nanotubes. The examples of the conductive material can be used alone or in combination of two or more thereof. In certain embodiments, the conductive material is selected from the group consisting of graphite, graphene, carbon nanotubes, and combinations thereof.

In certain embodiments, a content of the conductive material is in a range from 4 wt % to 40 wt % based on 100 wt % of the silicon-carbon composite material. In certain embodiments, the content of the conductive material is in a range from 5 wt % to 30 wt % based on 100 wt % of the silicon-carbon composite material. For example, the content of the conductive material can be 6 wt %, 8 wt %, 10 wt %, 16 wt %, 18 wt %, 20 wt %, 25 wt %, 26 wt %, or 28 wt % based on 100 wt % of the silicon-carbon composite material.

### Silicon-Containing Particle:

In certain embodiments, a content of the silicon-containing particle is in a range from 30 wt % to 90 wt % based on 100 wt % of the silicon-carbon composite material so as to enhance the specific capacity of the cathode thus produced. In certain embodiments, the content of the silicon-containing particle is in a range from 50 wt % to 85 wt % based on 100 wt % of the silicon-carbon composite material. In certain embodiments, the content of the silicon-containing particle is in a range from 70 wt % to 85 wt % based on 100 wt % of the silicon-carbon composite material.

In certain embodiments, the silicon-containing particle has a mean particle size ranging from 200 μm to 1000 μm.

The silicon-containing particle can be made from silicon, a silicon-containing compound, or a combination thereof. Examples of the silicon-containing compound include, but are not limited to, a silicon-containing solid solution, a silicon-containing intermetallic compound, a silicon oxide compound represented by SiOₓ wherein x is a value larger than 0 and up to 2.

The silicon-containing solid solution contains silicon and at least one element selected from the group consisting of Group IIA elements, Group IIIA elements, transitional metal elements, and Group IVA elements other than Si.

The silicon-containing intermetallic compound contains silicon and at least one element selected from the group consisting of Group IIA elements, Group IIIA elements, transitional metal elements, and Group IVA elements other than Si.

When the silicon-containing particle is made from both the silicon and the silicon-containing compound, a weight ratio of silicon to the silicon-containing compound is in a range from 3:7 to 7:3. In certain embodiments, the weight ratio of silicon to the silicon-containing compound is in a range from 4:6 to 6:4. In certain embodiments, when the silicon-containing particle is made from both the silicon and the silicon-containing compound, the silicon-containing compound is selected from the group consisting of the silicon-containing solid solution, the silicon-containing intermetallic compound, the silicon oxide compound represented by SiOₓ wherein x is a value larger than 0 and up to 2, and combinations thereof.

### Carbon Covering Layer:

In certain embodiments, the carbon covering layer has a thickness ranging from 0.01 μm to 10 μm so as to prevent the silicon-containing particle from being exposed from the carbon covering layer to interact with lithium ions in an electrolytic solution of a lithium-ion battery during discharging, and to permit the lithium ions in the electrolytic solution to penetrate through the carbon covering layer so as to interact with the silicon-containing particle to enhance the capacity.

The carbon covering layer includes pyrolytic carbon obtained via carbonization of a carbon-containing organic material selected from the group consisting of water-soluble polyvinyl alcohol, carboxymethyl cellulose, non-reducing sugar, sugar alcohol-based material, polydextrose, cellulose, starch, and combinations thereof.

In certain embodiments, the carbon covering layer includes the pyrolytic carbon obtained via carbonization of the carbon-containing organic material selected from the group consisting of the non-reducing sugar, the sugar alcohol-based material, and a combination thereof.

A non-limiting example of the non-reducing sugar is trehalose. Examples of the sugar alcohol-based material include, but are not limited to, xylose, erythritol, isomalt, glucose, fructose, galactose, and ribose. It should be noted that xylose and glucose cannot be used alone as the sugar alcohol-based material. The examples of the sugar alcohol-based material can be used alone or in combination of two or more thereof. In certain embodiments, the sugar alcohol-based material is selected from the group consisting of erythritol, isomalt, and a combination thereof.

In certain embodiments, a content of the carbon covering layer is in a range from 0.1 wt % to 30 wt % based on 100 wt % of the silicon-carbon composite material. In certain embodiments, the content of the carbon covering layer is in a range from 0.5 wt % to 20 wt % based on 100 wt % of the silicon-carbon composite material. For example, the content of the carbon covering layer can be 1 wt %, 3 wt %, 5 wt %, 7 wt %, 10 wt %, 11 wt %, 13 wt %, 15 wt %, or 17 wt % based on 100 wt % of the silicon-carbon composite material.

In certain embodiments, some of the conductive material can be dispersed in the carbon covering layer, and some of the conductive material can be covered by the carbon covering layer.

A method for preparing the silicon-carbon composite material according to the disclosure includes the steps of:

(a) providing a mixture including the silicon-containing particles, the conductive material, and the carbon-containing organic material; and

(b) subjecting the mixture to a heat treatment at a temperature ranging from 250° C. to 600° C.

In certain embodiments, in step (a), an amount of the carbon-containing organic material is in a range from 1 wt % to 80 wt % based on 100 wt % of the mixture.

In certain embodiments, the heat treatment is implemented for a period ranging from 1 hour to 10 hours.

The ratio of the integral area of the characteristic peak of sp² carbon to the total integral area of the characteristic peaks of the C1s orbital can be adjusted desirably by varying the temperature for the heat treatment and/or the types of the carbon-containing organic material. For example, when the sugar alcohol-based material is used as the carbon-containing organic material and the heat treatment is implemented at a temperature ranging from 250° C. to 600° C., the sugar alcohol-based material may not be carbonized completely such that the aforesaid ratio can be controlled in a range from 0.7 to 0.9. In certain embodiments, the aforesaid ratio is controlled in a range from 0.75 to 0.85.

The mixture used in step (a) can be prepared by mixing the silicon-containing particles, the conductive material, and the carbon-containing organic material in water, followed by removing the water. Water is used for dissolving the carbon-containing organic material.

The silicon-carbon composite material according to the disclosure can be used for producing a cathode of a lithium battery. The cathode can be produced by any suitable methods well known in the art. For example, the silicon-carbon composite material is added into a slurry for producing the cathode, followed by mixing evenly. Thereafter, the slurry added with the silicon-carbon composite material is coated on a substrate, followed by drying to produce the cathode. A non-limiting example of the substrate is a copper foil.

In addition to the silicon-carbon composite material, the slurry for producing the cathode includes any suitable carbon-based materials and additives well known in the art. Examples of the carbon-based materials include, but are not limited to, graphite, graphene, carbon nanotubes, and mesocarbon microbeads (MCMB). Examples of the additives include, but are not limited to, binding agents, tackifying agents, and conductive auxiliary agents.

Examples of the binding agents include, but are not limited to, ethylene-butadiene copolymer, methyl (meth)acrylate, ethyl (meth)acrylate, butyl (meth)acrylate, (meth)acrylonitrile, hydroxyethyl (meth)acrylate, acrylic acid, methacrylic acid, polyacrylic acid, fumaric acid, maleic acid, polyvinylidene difluoride, polyethylene oxide, epichlorohydrin, polyphosphazene, and polyacrylonitrile.

Examples of the tackifying agents include, but are not limited to, carboxymethylcellulose, methylcellulose, hydroxymethylcellulose, ethylcellulose, polyvinyl alcohol, and starch.

Examples of the conductive auxiliary agents include, but are not limited to, carbon black, graphite, and other conductive materials. The conductive auxiliary agent may be the same as or different from the aforesaid conductive material.

The cathode thus produced can be assembled with a lithium metal sheet (used as an anode), a separator, and an electrolytic solution to form a half battery. The materials for the separator and the electrolytic solution are not specifically limited and are well known in the art, and thus are not further described in detail herein.

Examples of the disclosure will be described hereinafter. It is to be understood that these examples are exemplary and explanatory and should not be construed as a limitation to the disclosure.

### Example 1: Preparation of a Silicon-Carbon Composite Material

Carbon nanotubes (2 g, Manufacturer: Cnano Technology Corporation, Jiangsu, China; Model: FT-7321), silicon powder (10 g, a mean particle size: 0.7 μm, Manufacturer: AUO Crystal Corporation, Taiwan; Model: ANI720), erythritol (10 g), and water (100 g) were placed in a container of a mixer (Manufacturer: Silverson; Model: L5M-A), followed by mixing using the mixer at a speed of 1000 rpm for 0.2 hour, and compressing under a reducing pressure in a vacuum controller (Manufacturer: BUCHI; Model: V-850) to remove water so as to obtain a mixture including the carbon nanotubes, the silicon powder, and erythritol.

The mixture was subjected to a heat treatment in a quartz furnace at a temperature of 600° C. for a period of 4 hours to obtain a silicon-carbon composite material (12.9 g), including the silicon powder, the carbon nanotubes, and a carbon covering layer. Some of the carbon nanotubes were dispersed in the carbon covering layer, and some of the carbon nanotubes were covered by the carbon covering layer. The carbon covering layer included pyrolytic carbon made from erythritol.

### Example 2: Preparation of a Silicon-Carbon Composite Material

The procedure of Example 1 was repeated except that erythritol used in Example 1 was replaced with isomalt (10 g) to obtain a silicon-carbon composite material (13.2 g).

### Example 3: Preparation of a Silicon-Carbon Composite Material

The procedure of Example 1 was repeated except that erythritol used in Example 1 was replaced with a mixture of erythritol (5 g) and trehalose (5 g) to obtain a silicon-carbon composite material (12.3 g).

### Example 4: Preparation of a Silicon-Carbon Composite Material

The procedure of Example 1 was repeated except that erythritol used in Example 1 was replaced with a mixture of erythritol (5 g) and isomalt (5 g) to obtain a silicon-carbon composite material (12.1 g).

### Example 5: Preparation of a Silicon-Carbon Composite Material

The procedure of Example 1 was repeated except that the silicon powder used in Example 1 was replaced with a mixture of the silicon powder (6 g) and a silicon oxide compound (4 g, SiOₓ wherein x is from 0.6 to 1.4, a mean particle size: 2 μm) to obtain a silicon-carbon composite material (12.2 g).

### Comparative Example 1

The procedure of Example 1 was repeated except that erythritol used in Example 1 was replaced with xylose (10 g) to obtain a silicon-carbon composite material (13.3 g).

### Comparative Example 2

The procedure of Example 1 was repeated except that erythritol used in Example 1 was replaced with lactitol (10 g) to obtain a silicon-carbon composite material (13.2 g).

### Comparative Example 3

The procedure of Example 1 was repeated except that erythritol used in Example 1 was replaced with sorbitol (10 g) to obtain a silicon-carbon composite material (13.3 g).

### Comparative Example 4

The procedure of Example 1 was repeated except that erythritol used in Example 1 was replaced with trehalose (10 g) to obtain a silicon-carbon composite material (13.5 g).

### Comparative Example 5

The procedure of Example 1 was repeated except that erythritol used in Example 1 was not added in Comparative Example 5 to obtain a silicon-carbon composite material (12.0 g).

### Comparative Example 6

The procedure of Example 1 was repeated except that erythritol used in Example 1 was replaced with glucose (10 g) to obtain a silicon-carbon composite material (13.2 g).

### Comparative Example 7

The procedure of Example 1 was repeated except that the heat treatment in Comparative Example 7 was implemented at a temperature of 1000° C. to obtain a silicon-carbon composite material (12.7 g).

### Property Evaluation:

### 1. Mean Particle Size:

The mean particle size of the silicon-carbon composite material of each of Examples 1 to 5 and Comparative Examples 1 to 7 was measured using a laser diffraction particle size analyzer (Manufacturer: Horiba; Model: LA-950).

### 2. Specific Surface Area:

The specific surface area of the silicon-carbon composite material of each of Examples 1 to 5 and Comparative Examples 1 to 7 was measured using a specific surface area analyzer (Manufacturer: BEL, Japan; Model: BELSORP-mini II). 0.2 g of the silicon-carbon composite material of each of Examples 1 to 5 and Comparative Examples 1 to 7 was placed in a test tube of the specific surface area analyzer, and was heated in a vacuum atmosphere at 150° C. for 1 hour, followed by a nitrogen adsorption treatment to obtain a BET specific surface area.

### 3. Tap Density:

The tap density of the silicon-carbon composite material of each of Examples 1 to 5 and Comparative Examples 1 to 7 was measured using a powder tapping-volume tester (Manufacturer: PREMA; Model: PT-20). The silicon-carbon composite material of each of Examples 1 to 5 and Comparative Examples 1 to 7 was placed in a graduated cylinder of the powder tapping-volume tester, and was vibrated for 200 cycles at a frequency of ⅓ hertz and at a gravity of 300 gw. The tap density of the silicon-carbon composite material was calculated according to the formula below.

Tap density=W₁/V₁

wherein

W₁ (g) is the weight of the silicon-carbon composite material prior to vibration; and

V₁ (cm³) is the volume of the silicon-carbon composite material after vibration.

### 4. Thickness of a Carbon Covering Layer:

The size of the silicon-carbon composite material of each of Examples 1 to 5 and Comparative Examples 1 to 7 was measured using a microscope. The thickness of the carbon covering layer was calculated by subtracting the mean particle size (i.e., 0.7 μm) of the silicon powder from the size of the silicon-carbon composite material.

### 5. Contents of Carbon, Oxygen, and Silicon Elements:

The silicon-carbon composite material of each of Examples 1 to 5 and Comparative Examples 1 to 7 was measured using an X-ray photoelectron spectrometer (Manufacturer: ULVAC-PHI; Model: PHI 5000 Versaprobe) to obtain a spectrum thereof. The contents of the carbon, oxygen, and silicon elements in the silicon-carbon composite material were calculated from the integral areas of the characteristic peaks of the carbon, oxygen, and silicon elements, respectively. Parameter conditions for this measurement include vacuum degree of 10⁻⁹ torr, X-ray source energy of 1486.6 eV, irradiation area of 100 μm×100 μm, analysis depth of 5 nm, and full spectrum energy scan range of from 0 to 1400 eV.

### 6. Contents of sp² Carbon, C—O, and C═O:

The silicon-carbon composite material of each of Examples 1 to 5 and Comparative Examples 1 to 7 was measured using the X-ray photoelectron spectrometer (Manufacturer: ULVAC-PHI; Model: PHI 5000 Versaprobe) to obtain a spectrum thereof. Parameter conditions for this measurement include vacuum degree of 10⁻⁹ torr, X-ray source energy of 1486.6 eV, irradiation area of 100 μm×100 μm, and analysis depth of 5 nm. The spectrum thus obtained was analyzed using an XPSpeak41 software. The peaks at a binding energy ranging from 280 eV to 298 eV were divided into the characteristic peak of sp2 carbon at a binding energy of 284.4 eV, the characteristic peak of C—O at a binding energy of 286 eV, and the characteristic peak of C═O at a binding energy of 287 eV.

The contents of sp² carbon, C—O, and C═O were calculated according to formulae (i), (ii), (iii) below, respectively.

Content of sp² carbon=(A/B)×100% (i)

Content of C—O═(C/B)×100% (ii)

Content of C═O=(D/B)×100% (iii)

wherein

A: an integral area of the characteristic peak of sp² carbon at a binding energy of 284.4 eV, and

B: a total of A, C, and D,

C: an integral area of the characteristic peak of C—O at a binding energy of 286 eV, and

D: an integral area of the characteristic peak of C═O at a binding energy of 287 eV.

The results of the aforesaid measurements for Examples 1 to 5 are shown in Table 1 below, and the results of the aforesaid measurements for Comparative Examples 1 to 7 are shown in Table 2 below.

TABLE 1

| | | | Example | | | | | | | | | |
|---|---|---|---|---|---|---|---|---|---|---|---|---|
| | | | 1 | | 2 | | 3 | | 4 | | 5 | |
| Mixture | Silicon- | Silicon | 10 | (45.5) | 10 | (45.5) | 10 | (47.6) | 10 | (47.6) | 6 | (28.56) |
| | containing | powder | | | | | | | | | | |
| | particle | g | | | | | | | | | | |
| | | (wt %) | | | | | | | | | | |
| | | Silicon oxide | 0 | (0) | 0 | (0) | 0 | (0) | 0 | (0) | 4 | (19.04) |
| | | of SiOₓ | | | | | | | | | | |
| | | (wt %) | | | | | | | | | | |
| | Conductive | Carbon | 2 | (9) | 2 | (9) | 1 | (4.8) | 1 | (4.8) | 1 | (4.8) |
| | material | nanotubes | | | | | | | | | | |
| | | g | | | | | | | | | | |
| | | (wt %) | | | | | | | | | | |

| | | | | | | | | | | |
|---|---|---|---|---|---|---|---|---|---|---|
| Carbon- | Erythritol | 10 | (45.5) | -- | 5 | (23.8) | 5 | (23.8) | 5 | (23.8) |

| | | | | | | | | | |
|---|---|---|---|---|---|---|---|---|---|
| containing | Isomalt | -- | 10 | (45.5) | -- | 5 | (23.8) | 5 | (23.8) |

| organic | Xylose | -- | -- | -- | | -- |
|---|---|---|---|---|---|---|
| material | Lactitol | -- | -- | -- | | -- |
| g | Sorbitol | -- | -- | -- | | -- |
| (wt %) | Trehalose | -- | -- | 5 | (23.8) | -- |

| | | Glucose | -- | -- | -- | -- | |
|---|---|---|---|---|---|---|---|
| Water | | | 100 | | | | |
| Heat treatment | | Temperature | 600 | | | | |
| | | (° C.) | | | | | |
| | | Period | 4 | | | | |
| | | (hour) | | | | | |
| Silicon- | Weight (g) | | 12.9 | 13.2 | 12.3 | 12.1 | 12.2 |
| carbon | Silicon-containing | | 77.5 | 75.8 | 81.3 | 82.6 | 82.0 |
| composite | particle (wt %) | | | | | | |
| material | Carbon nanotubes | | 15.5 | 15.1 | 8.1 | 8.3 | 8.2 |
| | (wt %) | | | | | | |
| | Carbon | Thickness | 1 | 1.2 | 0.8 | 1.0 | 1.0 |
| | covering | (μm) | | | | | |
| | layer | Content | 7.0 | 9.1 | 10.6 | 9.1 | 9.4 |
| | | (wt %) | | | | | |
| | | Pyrolytic | 7.0 | 9.1 | 10.6 | 9.1 | 9.4 |
| | | carbon | | | | | |
| | | (wt %) | | | | | |

| | | | | | |
|---|---|---|---|---|---|
| Mean particle size(μm) | 1 | 1 | 1.1 | 1.2 | 1 |
| Specific surface area (m²/g) | 18 | 16 | 12 | 15 | 10 |
| Tap density (g/cm³) | 0.32 | 0.32 | 0.34 | 0.31 | 0.34 |
| Content of carbon element (%) | 66 | 46 | 48 | 52 | 50 |
| Content of oxygen element (%) | 21 | 2.1 | 32 | 25 | 28 |
| Content of silicon element (%) | 11 | 31 | 20 | 23 | 28 |
| A/B | 0.84 | 0.80 | 0.75 | 0.77 | 0.76 |
| (A/B) × 100%[Content of sp² carbon(%)] | 84 | 80 | 75 | 77 | 76 |
| C/B | 0.11 | 0.19 | 0.20 | 0.22 | 0.21 |
| (C/B) × 100%[Content of C—O (%)] | 11 | 19 | 20 | 22 | 21 |
| D/B | 0.05 | 0 | 0.05 | 0.01 | 0.02 |
| (D/B) × 100%[Content of C═O (%)] | 5 | 0 | 5 | 1 | 2 |

Amount of the silicon-containing particles in the mixture (wt %): (Weight of the silicon-containing particles/Total weight of the silicon-containing particles, the conductive material, and the carbon-containing organic material) × 100%
Amount of the conductive material in the mixture (wt %): (Weight of the conductive material/Total weight of the silicon-containing particles, the conductive material, and the carbon-containing organic material) × 100%
Amount of the carbon-containing organic material (wt %): (Weight of the carbon-containing organic material/Total weight of the silicon-containing particles, the conductive material, and the carbon-containing organic material) × 100%
Content of the pyrolytic carbon in the silicon-carbon composite material (wt %): [(Weight of the silicon-carbon composite material − Total weight of the silicon-containing particle and the conductive material)/Weight of the silicon-carbon composite material] × 100%
Content of the silicon-containing particle in the silicon-carbon composite material (wt %): (Weight of the silicon-containing particle/Weight of the silicon-carbon composite material) × 100%
Content of the conductive material in the silicon-carbon composite material (wt %): (Weight of the conductive material/Weight of the silicon-carbon composite material) × 100%
Content of the carbon-covering layer in the silicon-carbon composite material (wt %): [(Weight of the silicon-carbon composite material − Total weight of the silicon-containing particle and the conductive material)/Weight of the silicon-carbon composite material] × 100%
--: not added

TABLE 2

| | | | Comparative Example | | | | | | | | | | | | | |
|---|---|---|---|---|---|---|---|---|---|---|---|---|---|---|---|---|
| | | | 1 | | 2 | | 3 | | 4 | | 5 | | 6 | | 7 | |
| Mixture | Silicon- | Silicon | 10 | (45.5) | 10 | (45.5) | 10 | (45.5) | 10 | (45.5) | 10 | (83) | 10 | (45.5) | 10 | (45.5) |
| | containing | powder | | | | | | | | | | | | | | |
| | particle | g | | | | | | | | | | | | | | |
| | | (wt %) | | | | | | | | | | | | | | |
| | | Silicon | 2 | (9) | 2 | (9) | 2 | (9) | 2 | (9) | 2 | (17) | 2 | (9) | 2 | (9) |
| | | oxide of | | | | | | | | | | | | | | |
| | | SiOₓ | | | | | | | | | | | | | | |
| | | (wt %) | | | | | | | | | | | | | | |

| | | | | | | | | | |
|---|---|---|---|---|---|---|---|---|---|
| Conductive | Carbon | -- | -- | -- | -- | -- | -- | 10 | (45.5) |
| material | nanotubes | | | | | | | | |
| Carbon- | g | | | | | | | | |
| containing | (wt %) | | | | | | | | |

| organic | Erythritol | -- | | -- | -- | -- | -- | -- | -- |
|---|---|---|---|---|---|---|---|---|---|
| material | Isomalt | 10 | (45.5) | -- | -- | -- | -- | -- | -- |

| | | | | | | | | | |
|---|---|---|---|---|---|---|---|---|---|
| g | Xylose | -- | 10 | (45.5) | -- | -- | -- | -- | -- |

| | | | | | | | | | |
|---|---|---|---|---|---|---|---|---|---|
| (wt %) | Lactitol | -- | -- | 10 | (45.5) | -- | -- | -- | -- |

| | | | | | | | | |
|---|---|---|---|---|---|---|---|---|
| Sorbitol | -- | -- | -- | 10 | (45.5) | -- | -- | -- |

| | | | | | | | | |
|---|---|---|---|---|---|---|---|---|
| Trehalose | -- | -- | -- | -- | -- | 10 | (45.5) | -- |

| Water | | | 100 | | | | | | |
|---|---|---|---|---|---|---|---|---|---|
| Heat treatment | | Temperature | 600 | | | | | | 1000 |
| | | (° C.) | | | | | | | |
| | | Period | 4 | | | | | | |
| | | (hour) | | | | | | | |
| Silicon- | Weight (g) | | 13.3 | 13.3 | 13.2 | 13.5 | 12 | 13.2 | 12.7 |
| carbon | Silicon-containing | | 75.2 | 75.8 | 75.2 | 74.1 | 83 | 75.8 | 78.75 |
| composite | particle (wt %) | | | | | | | | |
| material | Carbon nanotubes | | 15 | 15.1 | 15 | 14.8 | — | 15.2 | 15.74 |
| | (wt %) | | | | | | | | |
| | Carbon | Thickness | 1.1 | 1 | 1.2 | 1.2 | — | 1.2 | 1 |
| | covering | (μm) | | | | | | | |
| | layer | Content | 9.8 | 9.1 | 9.8 | 11.1 | — | 9 | 5.51 |
| | | (wt %) | | | | | | | |
| | | Pyrolytic | 9.8 | 9.1 | 9.8 | 11.1 | — | 9 | 5.51 |
| | | carbon | | | | | | | |
| | | (wt %) | | | | | | | |

| | | | | | | | |
|---|---|---|---|---|---|---|---|
| Mean particle size(μm) | 1.1 | 1.2 | 1.1 | 1 | 1.2 | 1 | 1 |
| Specific surface area (m²/g) | 16 | 18 | 16 | 18 | 20 | 15 | 25 |
| Tap density (g/cm³) | 0.33 | 0.30 | 0.31 | 0.31 | 0.30 | 0.32 | 0.33 |
| Content of carbon element (%) | 58 | 45 | 41 | 4.1 | 10 | 42 | 76 |
| Content of oxygen element (%) | 27 | 42 | 32 | 44 | 42 | 38 | 2 |
| Content of silicon element (%) | 13 | 12 | 25 | 12 | 44 | 10 | 22 |
| A/B | 0.57 | 0.58 | 0.67 | 0.56 | 0.72 | 0.60 | 0.96 |
| (A/B) × 100%[Content of sp² carbon(%)] | 57 | 58 | 67 | 56 | 72 | 60 | 96 |
| C/B | 0.32 | 0.40 | 0.30 | 0.36 | 0.20 | 0.30 | 0.1 |
| (C/B) × 100%[Content of C—O (%)] | 32 | 40 | 30 | 36 | 20 | 30 | 1 |
| D/B | 0.11 | 0.02 | 0.03 | 0.08 | 0.08 | 0.1 | 0.03 |
| (D/B) × 100%[Content of C═O (%)] | 11 | 2 | 3 | 8 | 8 | 10 | 3 |

Amount of the silicon-containing particles in the mixture (wt %): (Weight of the silicon-containing particles/Total weight of the silicon-containing particles, the conductive material, and the carbon-containing organic material) × 100%
Amount of the conductive material in the mixture (wt %): (Weight of the conductive material/Total weight of the silicon-containing particles, the conductive material, and the carbon-containing organic material) × 100%
Amount of the carbon-containing organic material (wt %): (Weight of the carbon-containing organic material/Total weight of the silicon-containing particles, the conductive material, and the carbon-containing organic material) × 100%
Content of the pyrolytic carbon in the silicon-carbon composite material (wt %): [(Weight of the silicon-carbon composite material − Total weight of the silicon-containing particle and the conductive material)/Weight of the silicon-carbon composite material] × 100%
Content of the silicon-containing particle in the silicon-carbon composite material (wt %): (Weight of the silicon-containing particle/Weight of the silicon-carbon composite material) × 100%
Content of the conductive material in the silicon-carbon composite material (wt %): (Weight of the conductive material/Weight of the silicon-carbon composite material) × 100%
Content of the carbon-covering layer in the silicon-carbon composite material (wt %): [(Weight of the silicon-carbon composite material − Total weight of the silicon-containing particle and the conductive material)/Weight of the silicon-carbon composite material] × 100%
--: not added
—: None

### Application Example 1: Preparation of Cathode and Lithium Battery

Polyacrylic acid (1.2 g, as a binding agent) was mixed with water (50 g) to form an aqueous solution of polyacrylic acid. The silicon-carbon composite material of Example 1 (3.84 g) and conductive carbon black (0.4 g, as a conductive auxiliary agent, Manufacturer: TIMCAL Graphite & Carbon; Model: Super P®) were added to the aqueous solution of polyacrylic acid, followed by mixing under stirring using a DC-stirrer at a speed of from 1000 rpm to 1500 rpm for 30 minutes to form a mixture. A solution of carboxymethylcellulose (Manufacturer: Ashland; Model: Bondwell™ BVH8) was added to the mixture, followed by mixing under stirring using the DC-stirrer at a speed of 1000 rpm for 30 minutes. Graphite T8 (34.6 g, Manufacturer: Tianjin Kimwan Carbon Technology and Development Co. Ltd., China; Model: TS) was finally added, followed by mixing under stirring using the DC-stirrer at a speed of 1000 rpm for 30 minutes and then at a speed of 2000 rpm for 120 minutes to obtain a slurry with a mean particle size of less than 30 μm. The slurry was applied on a copper foil using a doctor blade. The copper foil applied with the slurry was dried in an oven at a temperature of 100° C. for a period of 5 minutes, followed by cutting using a cutter to form a circular electrode sheet having a diameter of 1.3 cm. The circular electrode sheet was roller-compacted to form a roller-compacted sheet having a tap density of from 1.4 g/cm³ to 1.5 g/cm³. The roller-compacted sheet was cut using the cutter to form a cathode sheet having a thickness of 40 μm and a diameter of 12 mm. The cathode sheet thus formed included a cathode which was formed from the slurry and which has a thickness of 30 μm and a coating weight of 4 mg.

The cathode sheet was dried at a temperature of 90° C. in a vacuum atmosphere for 1 hour, and was then assembled with a lithium metal sheet (used as an anode), a polypropylene separator (thickness: 20 μm), and an electrolytic solution (75 μl) in an argon atmosphere to obtain a CR2032 coin cell, which was permitted to stand for a period of from 2 hours to 3 hours to obtain a lithium battery having an open circuit voltage of from 2.5 V to 3V. The electrolytic solution was preparing from lithium hexafluorophosphate (LiPF₆), ethylene carbonate (EC), and diethyl carbonate (DEC) wherein a volume ratio of ethylene carbonate to diethyl carbonate is 1/1.

### Application Examples 2 to 5 and Comparative Application Examples 1 to 7

The procedure of Application Example 1 was repeated except that the materials and the amounts thereof shown in Table 3 for each of Application Examples 2 to 5 and Comparative Application Examples 1 to 7 were used.

### Property Evaluation:

1. Discharge Capacity (mAh/g):

The lithium battery of each of Application Examples 1 to 5 and Comparative Application Examples 1 to 7 was subjected to a constant-current discharge (current: 500 mAh/g×(weight of a cathode)) using a battery test equipment (Manufacturer: ARBIN Instruments; Model: LBT21084) at a discharge velocity of 0.1 C. The discharge was terminated at a voltage of 0.01 V, followed by maintaining at a voltage of 0.01 V for 1 hour. Thereafter, the lithium battery was subjected to a constant-current charge at a charge velocity of 0.1 C. The charge was terminated at a voltage of 2V.

### 2. First Cycle Coulombic Efficiency (%):

The first cycle coulombic efficiency was calculated according to the formula below.

First cycle coulombic efficiency=(C_{1-disc}/C_{1-c})×100%

wherein

C_{1-disc}: a first cycle discharge capacity; and

C_{1-c}: a first cycle charge capacity.

The first cycle charge capacity was measured using the battery test equipment (Manufacturer: ARBIN Instruments; Model: LBT21084). Specifically, the lithium battery of each of Application Examples 1 to 5 and Comparative Application Examples 1 to 7 was subjected to a constant-current charge (current: 500 mAh/g×(weight of a cathode)) using the battery test equipment at a charge velocity of 0.1 C. The discharge was terminated at a voltage of 0.01 V. Thereafter, a constant-voltage charge was implemented at a voltage of 0.01 V and a charge velocity of 0.1 C until 1% of a setting current (500 mAh/g×(weight of a cathode)) was reached.

### 3. Capacity Holding Ratio:

A capacity holding ratio was calculated according to the formula below.

Capacity holding ratio=(C_{20-disc}/C_{1-disc})×100%

wherein

C_{20-disc}: a 20^{th} cycle discharge capacity; and

C_{1-disc}: a first cycle discharge capacity.

TABLE 3

| | | Application Example | | | | | Comparative Application Example | | | | | | |
|---|---|---|---|---|---|---|---|---|---|---|---|---|---|
| Cathode | | 1 | 2 | 3 | 4 | 5 | 1 | 2 | 3 | 4 | 5 | 6 | 7 |
| Silicon- | Example | 1 | 2 | 3 | 4 | 5 | — | — | — | — | — | — | — |
| carbon | Comp. Ex. | — | — | — | — | — | 1 | 2 | 3 | 4 | 5 | 6 | 7 |
| composite | Amount | 3.84 | 3.84 | 3.84 | 3.84 | 4.30 | 3.84 | 3.84 | 3.84 | 3.84 | 3.84 | 3.84 | 3.84 |
| material | (g) | | | | | | | | | | | | |
| Binding | Polyacrylic | 1.2 | 1.2 | 1.2 | 1.2 | 1.2 | 1.2 | 1.2 | 1.2 | 1.2 | 1.2 | 1.2 | 1.2 |
| agent | acid | | | | | | | | | | | | |
| | (g) | | | | | | | | | | | | |
| Conductive | Conductive | 0.4 | 0.4 | 0.4 | 0.4 | 0.4 | 0.4 | 0.4 | 0.4 | 0.4 | 0.4 | 0.4 | 0.4 |
| auxiliary | carbon | | | | | | | | | | | | |
| agent | black | | | | | | | | | | | | |
| | (g) | | | | | | | | | | | | |
| Graphite (g) | | 34.6 | 34.6 | 34.6 | 34.6 | 30 | 34.6 | 34.6 | 34.6 | 34.6 | 34.6 | 34.6 | 34.6 |
| Lithium | 1^{st} cycle | 485 | 477 | 462 | 470 | 480 | 462 | 473 | 420 | 508 | 608 | 460 | 550 |
| battery | discharge | | | | | | | | | | | | |
| | capacity | | | | | | | | | | | | |
| | 1^{st} cycle | 87 | 89 | 88 | 87 | 88 | 89 | 87 | 87 | 91 | 84 | 87 | 89 |
| | coulombic | | | | | | | | | | | | |
| | efficiency | | | | | | | | | | | | |
| | (%) | | | | | | | | | | | | |
| | 5^{th} cycle | 487 | 477 | 468 | 472 | 479 | 460 | 468 | 420 | 480 | 557 | 455 | 536 |
| | discharge | | | | | | | | | | | | |
| | capacity | | | | | | | | | | | | |
| | 10^{th} cycle | 483 | 453 | 458 | 457 | 476 | 434 | 340 | 180 | 458 | 373 | 429 | 510 |
| | discharge | | | | | | | | | | | | |
| | capacity | | | | | | | | | | | | |
| | 12^{th} cycle | 478 | 444 | 445 | 448 | 476 | 426 | 321 | 133 | 447 | 324 | 420 | 502 |
| | discharge | | | | | | | | | | | | |
| | capacity | | | | | | | | | | | | |
| | 15^{th} cycle | 469 | 430 | 432 | 436 | 475 | 408 | 296 | 91 | 430 | 284 | 408 | 489 |
| | discharge | | | | | | | | | | | | |
| | capacity | | | | | | | | | | | | |
| | 20^{th} cycle | 450 | 427 | 416 | 428 | 474 | 378 | 263 | 50 | 422 | 244 | 396 | 460 |
| | discharge | | | | | | | | | | | | |
| | capacity | | | | | | | | | | | | |
| | Capacity | 93 | 90 | 90 | 91 | 98.7 | 82 | 55 | 12 | 83 | 40 | 86 | 83.6 |
| | holding | | | | | | | | | | | | |
| | ratio | | | | | | | | | | | | |
| | (%) | | | | | | | | | | | | |

As shown in Table 3, the lithium battery including the cathode produced from the silicon-carbon composite material of the disclosure has a first cycle coulombic efficiency of larger than 87%, a first cycle discharge capacity of larger than 440 mAh/g, and a capacity holding ratio of at least 90%.

In addition, as shown from the results of Application Examples 1 to 5 and Comparative Application Examples 1 to 4, 6, and 7, when the ratio of the integral area of the characteristic peak of sp² carbon in the X-ray photoelectron spectrum of the silicon-carbon composite material to the total integral area of the characteristic peaks of Cis orbital in the X-ray photoelectron spectrum is less than 0.7 or larger than 0.9, the lithium battery including the cathode produced from the silicon-carbon composite material has a capacity holding ratio of from 12% to 86%. When the ratio of the integral area of the characteristic peak of sp carbon in the X-ray photoelectron spectrum of the silicon-carbon composite material to the total integral area of the characteristic peaks of C1s orbital in the X-ray photoelectron spectrum is in a range from 0.7 to 0.9, the lithium battery including the cathode produced from the silicon-carbon composite material has a capacity holding ratio of from 90% to 98.7%, indicating that the capacity holding ratio of the lithium battery including the cathode can be enhanced using the silicon-carbon composite material of the disclosure.

Furthermore, as shown from the results of Application Examples 1 to 5 and Comparative Application Example 5, although in Comparative Application Example 5, the ratio of the integral area of the characteristic peak of sp² carbon in the X-ray photoelectron spectrum of the silicon-carbon composite material to the total integral area of the characteristic peaks of C1s orbital in the X-ray photoelectron spectrum is in a range from 0.7 to 0.9, the silicon-carbon composite material used for producing the cathode of the lithium battery does not include the carbon covering layer, and the capacity holding ratio of the lithium battery is merely 40%. In each of Application Examples 1 to 5, the silicon-carbon composite material used for producing the cathode of the lithium battery includes the carbon covering layer, and the capacity holding ratio of the lithium battery is at least 90% (i.e., in a range from 90% to 98.7%).

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A silicon-carbon composite material, comprising:
a silicon-containing particle;
a carbon covering layer enclosing said silicon-containing particle; and
a conductive material included in at least one of said silicon-containing particle and said carbon covering layer,
wherein a ratio of an integral area of a characteristic peak of sp² carbon in an X-ray photoelectron spectrum of said silicon-carbon composite material to a total integral area of characteristic peaks of C1s orbital in the X-ray photoelectron spectrum is in a range from 0.7 to 0.9.

2. The silicon-carbon composite material according to claim 1, wherein said carbon covering layer includes pyrolytic carbon obtained via carbonization of a carbon-containing organic material selected from the group consisting of water-soluble polyvinyl alcohol, carboxymethyl cellulose, non-reducing sugar, sugar alcohol-based material, polydextrose, cellulose, starch, and combinations thereof.

3. The silicon-carbon composite material according to claim 2, wherein said carbon-containing organic material is selected from the group consisting of said non-reducing sugar, said sugar alcohol-based material, and a combination thereof.

4. The silicon-carbon composite material according to claim 3, wherein carbon-containing organic material is said sugar alcohol-based material selected from the group consisting of erythritol, isomalt, and a combination thereof.

5. The silicon-carbon composite material according to claim 1, wherein said carbon covering layer has a thickness ranging from 0.01 μm to 10 μm.

6. The silicon-carbon composite material according to claim 1, wherein a content of said carbon covering layer is in a range from 0.1 wt % to 30 wt % based on 100 wt % of said silicon-carbon composite material.

7. The silicon-carbon composite material according to claim 1, having a mean particle size ranging from 1 μm to 30 μm.

8. The silicon-carbon composite material according to claim 1, having a specific surface area ranging from 1.0 m²/g to 30.0 m²/g.

9. The silicon-carbon composite material according to claim 1, having a tap density ranging from 0.3 g/cm³ to 2.0 g/cm³.

10. The silicon-carbon composite material according to claim 1, wherein said silicon-containing particle is made from a silicon-containing material selected from the group consisting of silicon, a silicon-containing solid solution, a silicon-containing intermetallic compound, a silicon oxide compound represented by SiOₓ wherein x is a value larger than 0 and up to 2, and combinations thereof.

11. The silicon-carbon composite material according to claim 1, wherein a content of said silicon-containing particle is in a range from 30 wt % to 90 wt % based on 100 wt % of said silicon-carbon composite material.

12. The silicon-carbon composite material according to claim 11, wherein the content of said silicon containing particle is in a range from 50 wt % to 85 wt % based on 100 wt % of said silicon-carbon composite material.

13. The silicon-carbon composite material according to claim 1, wherein said conductive material is selected from the group consisting of graphite, graphene, carbon nanotubes, and combinations thereof.

14. A method for preparing the silicon-carbon composite material of claim 1, comprising the steps of:
(a) providing a mixture including the silicon-containing particle, the conductive material, and a carbon-containing organic material; and
(b) subjecting the mixture to a heat treatment at a temperature ranging from 250° C. to 600° C.
